(19) United States
(12) Patent Application Publication
(10) Pub. No.: US 2013/0051560 A1
(43) Pub. Date: Feb. 28, 2013

(54) 3-Dimensional Audio Projection

(71) Applicants: Michael S. Ray, Carmel, IN (US); James A. Negro, Plainfield, IN (US); Brian T. Hardman, Greenwood, IN (US)

(72) Inventors: Michael S. Ray, Carmel, IN (US); James A. Negro, Plainfield, IN (US); Brian T. Hardman, Greenwood, IN (US)

(73) Assignee: RAYTHEON COMPANY, Waltham, MA (US)

(21) Appl. No.: 13/221,297

(22) Filed: Aug. 30, 2011

(51) Int. Cl. H04H 20/88

(52) U.S. Cl. 381/2

(57) ABSTRACT

Described are computer-based methods and apparatuses, including computer program products, for audio data processing. In some examples, a 3-dimensional audio projection method includes receiving a first set of audio transmissions, each of the audio transmissions in the first set of audio transmissions comprises audio data and location data; determining, for each of the audio transmissions in the first set of audio transmissions, a relative location of the audio transmission based on a location of a receiver and the location data; and projecting, for each of the audio transmissions in the first set of audio transmissions, the audio data to a user in a 3-dimensional format based on the relative location of the audio transmission.

### BACKGROUND

Generally, when audio is transmitted (e.g., radio, telephone, voice over internet protocol, etc.), the audio loses spatial 3-dimensional quality and the audio is expressed as a directionless 2-dimensional sound to the listener. In some situations, the reconstruction and restoration of the missing third dimension of the transmitted sound to 3-dimensional sound is desirable to the listener. After reconstruction and restoration, the listener would then know from which direction the transmitted sound originated, such as air-to-air, air-to-ground, or ground-to-ground telecommunications where the listener desires to know the direction of the transmitter relative to the listener in the auditory spectrum. Thus, a need exists in the art for improved 3-dimensional audio projection.

### SUMMARY

One approach is a system that projects 3-dimensional audio. The system includes a communication module configured to receive a plurality of audio transmissions, each of the plurality of audio transmissions comprises audio data and location data and the location data being associated with a transmitter location; an audio location module configured to determine, for each of the plurality of audio transmissions, a relative location of the audio transmission based on a location of the system and the location data; and an audio projection module configured to 3-dimensionally project, for each of the plurality of audio transmissions, the audio data to a user based on the relative location of the audio transmission.

Another approach is a method for projecting 3-dimensional audio. The method includes receiving a first set of audio transmissions, each of the audio transmissions in the first set of audio transmissions comprises audio data and location data; determining, for each of the audio transmissions in the first set of audio transmissions, a relative location of the audio transmission based on a location of a receiver and the location data; and projecting, for each of the audio transmissions in the first set of audio transmissions, the audio data to a user in a 3-dimensional format based on the relative location of the audio transmission.

One approach is a computer program product that projects 3-dimensional audio. The computer program product is tangibly embodied in an information carrier. The computer program product includes instructions being operable to cause a data processing apparatus to: receive a set of audio transmissions, each of the audio transmissions in the set of audio transmissions comprises audio data and location data and each of the audio transmissions in the set of audio transmissions being associated with a distinct transmitter location; determine, for each of the audio transmissions in the set of audio transmissions, a relative location of the audio transmission based on a location of a receiver and the location data; and project, for each of the audio transmissions in the set of audio transmissions, the audio data to a user in a 3-dimensional format based on the relative location of the audio transmission.

In other examples, any of the approaches above can include one or more of the following features.

In some examples, each of the plurality of audio transmissions are received on a same communication channel.

In other examples, the plurality of audio transmissions includes two or more audio transmissions transmitted from a transmitter at different locations and at different times.

In some examples, the plurality of audio transmissions includes two or more audio transmissions transmitted at a same time from different users in a vehicle.

In other examples, the system further includes a user orientation module configured to determine a user orientation with respect to the location of the system; and the audio projection module is further configured to 3-dimensionally project, for each of the plurality of audio transmissions, the audio data to a user based on the relative location of the audio transmission and the user orientation.

In some examples, the system further includes a location determination module configured to determine the location of the system.

In other examples, the system further includes an audio separation module configured to separate the audio data and the location data from the each of the plurality of audio transmissions.

In some examples, the method further includes receiving a second set of audio transmissions, each of the audio transmissions in the second set of audio transmissions comprises second audio data and second location data; determining, for each of the audio transmissions in the second set of audio transmissions, a second relative location of the audio transmission based on a location of the receiver and the second location data; and projecting, for each of the audio transmissions in the second set of audio transmissions, the audio data to a user in a 3-dimensional format based on the second relative location of the audio transmission.

In other examples, each of the audio transmissions in the first set of audio transmissions and each of the audio transmissions in the second set of audio transmissions are received on a same communication channel.

In some examples, each of the audio transmissions in the first set of audio transmissions are received at a first time, each of the audio transmissions in the second set of audio transmissions are received at a second time, and the first time and the second time are different.

In other examples, the relative location for each of the audio transmissions in the first set of audio transmissions comprises a vector between the receiver and a transmitter location.

The 3-dimensional audio projection techniques described herein can provide one or more of the following advantages. An advantage of the technology is multiple users (transmitters) can communicate 3-dimensional audio to a single user (receiver), thereby enabling the single user to determine the approximate spatial relationship of the multiple users from the single user's location (e.g., transmitter is to the receiver's left, transmitter is to the receiver's right, etc.). Another advantage of the technology is the location data is embedded within the audio transmission, thereby reducing processing time for 3-dimensional audio projection by removing the need to correlate the location data and the audio data. Another advantage of the technology is that the projection of the 3-dimensional audio can occur in real-time with the transmission of the audio data due to the location data being embedded in the audio transmission, thereby enabling the technology to be utilized in real-time situations (e.g., emergency situation, fast-moving vehicles, etc.).

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an exemplary 3-dimensional audio projection environment;

FIG. 2 is a diagram of another exemplary 3-dimensional audio projection environment;

FIG. 3 is a block diagram of an exemplary 3-dimensional audio system;

FIG. 4 is a bock diagram of another exemplary 3-dimensional audio system;

FIG. 5 is a flowchart of an exemplary 3-dimensional audio projection method; and

FIG. 6 is a flowchart of another exemplary 3-dimensional audio projection method.

### DETAILED DESCRIPTION

The 3-dimensional audio projection method and apparatus includes technology that, generally, provides spatial recognition of the audio source to the listener by projecting audio (e.g., acoustic sound waves) into a 3-dimensional space based on a relative location of a receiver of the audio from a transmitter of the audio. The technology can embed geo-coordinates (e.g., global positioning system (GPS), internal navigation system, etc.) of a transmitter into a voice stream (e.g., user speaking over a radio, user speaking over a satellite phone, etc.) for spatial recognition of the audio source by the listener. A receiver decodes the embedded geo-coordinates of the transmitted signal and compares the receiver's geo-coordinates to the transmitter's geo-coordinates to determine the direction of the transmitter relative to the receiver (e.g., receiver is four miles due west of transmitter, receiver is one thousand feet northeast of transmitter, etc.). The receiver processes the voice stream to project the received audio into 3-dimensional (3D) space at the receiver utilizing the determination of the direction of the transmitter relative to the receiver (e.g., audio projected from rear speakers, audio projected as if communicated from northwest of receiver, etc.). The technology advantageously embeds a third dimension (relative location and direction) to the audio, thereby allowing the listener to identify the transmitter's location relative to the listener's location.

The technology can be utilized by various listeners to project the audio into a 3D space so that the listeners can spatially determine the source of the audio (e.g., faster response to an emergency, faster distinction between multiple transmitters, etc.). The various listeners can, for example, include, but are not limited to first responders, air traffic controllers, gaming, firefighters, pilots, cellular telephone users (e.g., using stereo ear buds), search-and-rescue personnel, racing car drivers/pit crews, geo-cache explorers, endangered species trackers, and/or any other type of location specific users. The various listeners can, for example, utilize any type of transmitter or location transmitting device including, but not limited to locator/marker beacons, marine telecommunications/radios, and/or any other location specific devices.

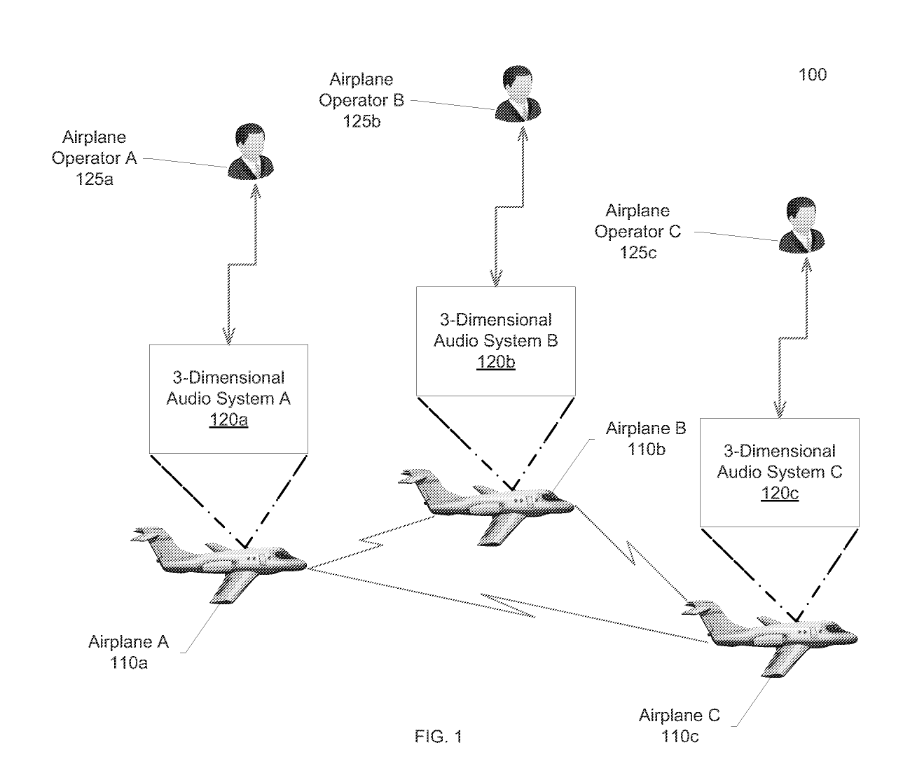

FIG. 1 is a diagram of an exemplary 3-dimensional audio projection environment 100. The environment 100 includes airplanes A 110a, B 110b, and C 110c (generally, airplane 110) flying in, for example, formation. Each airplane A 110a, B 110b, and C 110c includes a 3-dimensional audio system A 120a, B 120b, and C 120c, respectively, for spatial recognition of the audio source by the listeners (in this example, one or more airplane operators A 125a, B 125b, and C 125c). The one or more airplane operators A 125a, B 125b, and C 125c (e.g., a pilot, a co-pilot, a radar operator, a passenger, etc.) are in each airplane A 110a, B 110b, and C 110c, respectively. The one or more airplane operators A 125a, B 125b, and C 125c in the airplanes A 110a, B 110b, and C 110c communicate among themselves via receivers and/or transmitters (e.g., directly via radio transceivers, indirectly via satellite receivers and/or transmitters, etc.). The 3-dimensional audio system A 120a, B 120b, and C 120c in each airplane A 110a, B 110b, and C 110, respectively, processes the communication between the one or more airplane operators A 125a, B 125b, and C 125c to 3-dimensionally project the communication to the respective operator such that the respective operator can determine a direction from which the audio is coming from.

In operation, the airplane operator A 125a utilizes the 3-dimensional audio system A 125a to transmit a voice communication (e.g., ten second voice message, one second voice message, etc.) to the airplane operator C 125c via the 3-dimensional audio system C 120c. The 3-dimensional audio system A 125a embeds location data (e.g., GPS coordinates of the airplane A 110a) of the 3-dimensional audio system A 125a into the voice communication to form an audio transmission. The 3-dimensional audio system A 125a transmits the audio transmission to the 3-dimensional audio system C 125c (e.g., radio transmission, satellite transmission, optical transmission, etc.). The 3-dimensional audio system C 125c receives the audio transmission and determines the relative location of the airplane C 110c to the airplane A 110a based on the location data embedded into the audio transmission and the location of the airplane C 110c (e.g., airplane C 110c is below airplane A 110a, airplane C 110c is four miles behind airplane A 110a, etc.). The 3-dimensional audio system C 125c projects the voice communication to the airplane operator C 125c (e.g., the 3-dimensional audio system C 125c projects the voice communication from the left speakers in the cockpit of the airplane C 110c to indicate that the airplane A 110a is to the left of the airplane C 110c) such that the airplane operator C 125c can determine the relative location of the voice communication.

In some examples, the 3-dimensional audio system C 125c simultaneously receives audio transmissions from the 3-dimensional audio system A 125a and the 3-dimensional audio system B 125b. The 3-dimensional audio system C 125c determines the relative location of the airplane C 110c to the airplane A 110a and airplane B 110b, respectively, based on the respective location data embedded into the respective audio transmission and the location of the airplane C 110c. The 3-dimensional audio system C 125c projects the voice communication transmitted from the airplane A 110a and the airplane B 110b to the airplane operator C 125c based on the respective relative location (e.g., northwest, below, above, behind, etc.), thereby enabling the airplane operator C 125c to determine the relative location of the voice communication. The technology can advantageously simultaneously project voice communications from a plurality of transmitters, thereby increasing the functional uses of the technology (e.g., multiple first responders can communicate with each other simultaneously, multiple airplane operators can communicate with a radar operator simultaneously, etc.) and enabling the operators to determine the relative location of the voice communication.

Although FIG. 1 illustrates airplanes A 110a, B 110b, and C 110c and airplane operators A 125a, B 125b, and C 125c, the technology can be utilized in any type of environment (e.g., mixed environment with airplanes and tanks, environment with helicopters, environment with first responders, etc.) and/or by any type of operator (e.g., vehicle drivers, remote vehicle operators, radar controllers, first responders, incident commanders, etc.). Although FIG. 1 illustrates three airplanes A 110a, B 110b, and C 110c and three airplane operators A 125a, B 125b, and C 125c, the technology can be utilized by any number of airplanes (e.g., twenty airplanes, one hundred airplanes, etc.) and/or airplane operators (e.g., a single airplane with ten airplane operators, two airplanes with five airplane operators each, etc.). For example, a team of first responders in a building can communicate with each other via the technology and each first responder in the team can identify the relative location of the other first responders during voice communication via the 3-dimensional audio projection described herein.

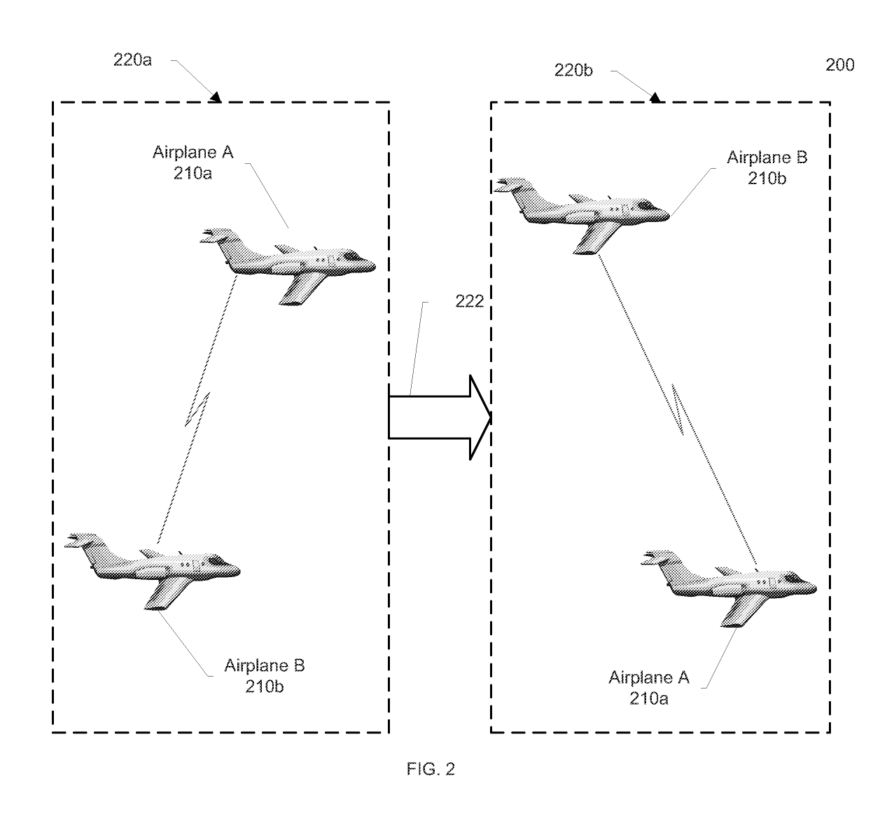

FIG. 2 is a diagram of another exemplary 3-dimensional audio projection environment 200. The environment 200 includes airplanes A 210a and B 210b at two different times 220a and 220b (e.g., 03:45.23 and 03:45.53, 04:33 and 04:45, etc.). As illustrated in FIG. 2, the airplanes A 210a and B 210b change positions (222) between the times 220a and 220b. At time 220a, for example, a voice communication from the airplane A 210a to the airplane B 210b is projected in upper, front speakers in a cockpit of the airplane B 210b. At time 220b, for example, a voice communication from the airplane A 210a to the airplane B 210b is projected in upper, rear speakers in the cockpit of the airplane B 210b. The technology advantageously enables a receiver to determine the relative location of a speaker with respect to a transmitter, thereby increasing the value of a voice communication by adding a third dimension (relative location) to the audio output. In other examples, the audio is projected utilizing a single speaker (e.g., acoustic projection system) or a double speaker (e.g., headset) audio system.

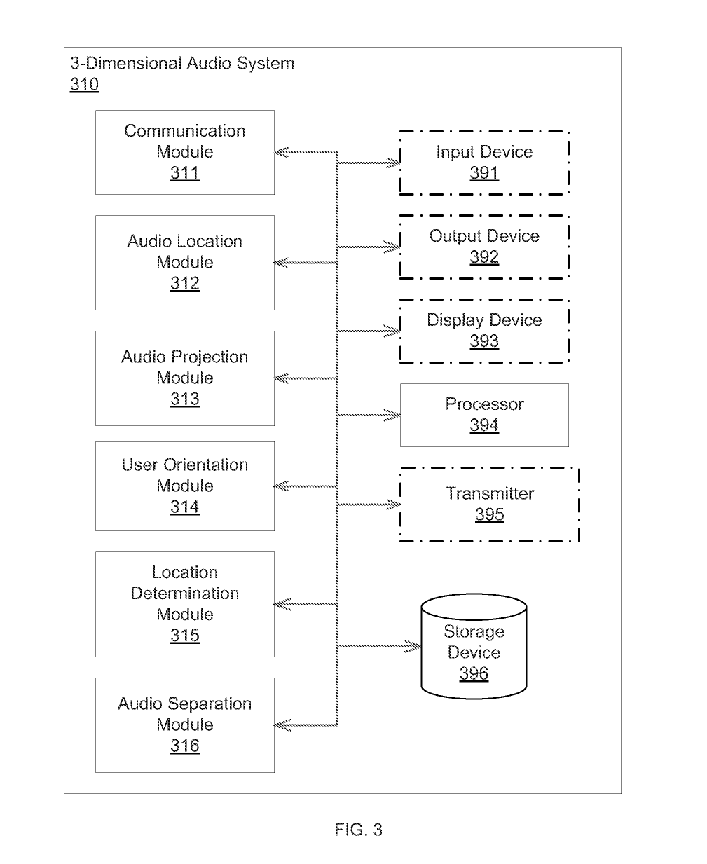

FIG. 3 is a diagram of a 3-dimensional audio system 310. The 3-dimensional audio system 310 includes a communication module 311, an audio location module 312, an audio projection module 313, a user orientation module 314, a location determination module 315, an audio separation module 316, an input device 391, an output device 392, a display device 393, a processor 394, a transmitter 395, and a storage device 396. The input device 391, the output device 392, the display device 393, and the transmitter 395 are optional devices/components. The modules and devices described herein can, for example, utilize the processor 394 to execute computer executable instructions and/or include a processor to execute computer executable instructions (e.g., an encryption processing unit, a field programmable gate array processing unit, etc.). It should be understood that the 3-dimensional audio system 310 can include, for example, other modules, devices, and/or processors known in the art and/or varieties of the illustrated modules, devices, and/or processors.

The communication module 311 communicates information to/from 3-dimensional audio system 310. The communication module 311 receives a plurality of audio transmissions. Each of the plurality of audio transmissions includes audio data and location data and the location data is associated with a transmitter location.

The audio location module 312 determines, for each of the plurality of audio transmissions, a relative location of the audio transmission based on a location of the system and the location data (e.g., transmitter is south of receiver based on GPS coordinates, transmitter is four miles north of receiver based on GPS coordinates, etc.). The audio projection module 313 3-dimensionally projects, for each of the plurality of audio transmissions, the audio data to a user based on the relative location (e.g., rear projection of audio into receiver cockpit because transmitter is behind receiver, front projection of audio into receiver headset because transmitter is in front of receiver, etc.). In some examples, the audio projection module 313 3-dimensionally projects, for each of the plurality of audio transmissions, the audio data to a user based on the relative location and the user orientation.

The user orientation module 314 determines a user orientation with respect to the location of the system (e.g., user is looking to the left of the system, user is turned to the right of the system, etc.). The location determination module 315 determines the location of the system (e.g., GPS coordinates, relative location to a landmark, etc.). The audio separation module 316 separates the audio data and the location data from the each of the plurality of audio transmissions (e.g., digitally decodes the audio data and the location data, filters the location data from the audio data via an analog filter, etc.).

The input device 391 receives information associated with the 3-dimensional audio system 310 (e.g., instructions from a user, instructions from another computing device, etc.) from a user (not shown) and/or another computing system (not shown). The input device 391 can include, for example, a keyboard, a scanner, etc. The output device 392 outputs information associated with the 3-dimensional audio system 310 (e.g., information to a printer (not shown), information to a speaker, etc.).

The display device 393 displays information associated with the 3-dimensional audio system 310 (e.g., status information, configuration information, etc.). The processor 394 executes the operating system and/or any other computer executable instructions for the 3-dimensional audio system 310 (e.g., executes applications, etc.).

The storage device 396 stores position information and/or relay device information. The storage device 396 can store information and/or any other data associated with the 3-dimensional audio system 310. The storage device 396 can include a plurality of storage devices and/or the 3-dimensional audio system 310 can include a plurality of storage devices (e.g., a position storage device, a satellite position device, etc.). The transmitter 395 can send and/or receive transmission from and/or to the 3-dimensional audio system 310. The storage device 396 can include, for example, long-term storage (e.g., a hard drive, a tape storage device, flash memory, etc.), short-term storage (e.g., a random access memory, a graphics memory, etc.), and/or any other type of computer readable storage.

In some examples, each of the plurality of audio transmissions is received on a same communication channel (e.g., channel 9, 40 megahertz, etc.). In other examples, the plurality of audio transmissions includes two or more audio transmissions transmitted from a transmitter at different locations and at different times. In some examples, the plurality of audio transmissions includes two or more audio transmissions transmitted at a same time from different users in a vehicle. Table 1 illustrates a plurality of audio transmissions from different transmitters and/or different users.

TABLE 1
Audio Transmissions

| | Transmitter | | Receiver | | |
|---|---|---|---|---|---|
| Transmitter | Location | Receiver | Location | Time | Channel |
| Airplane A | Location 1H | Airplane B | Location | 2:02.21 | A |
| 110a | | 110b | 1G | | |
| Airplane A | Location 2H | Airplane B | Location | 2:06.21 | A |
| 110a | | 110b | 2G | | |
| Airplane A | Location 3H | Airplane B | Location | 2:05.21 | B |
| 110a | | 110b | 5G | | |
| Airplane A | Location 6H | Airplane B | Location | 2:08.21 | F |
| 110a - | | 110b - | 3G | | |
| User B | | User D | | | |
| Airplane A | Location 6H | Airplane B | Location | 2:08.21 | F |
| 110a - | | 110b - | 3G | | |
| User C | | User D | | | |
| Airplane A | Location 6H | Airplane B | Location | 2:08.21 | L |
| 110a - | | 110b - | 3G | | |
| User F | | User D | | | |

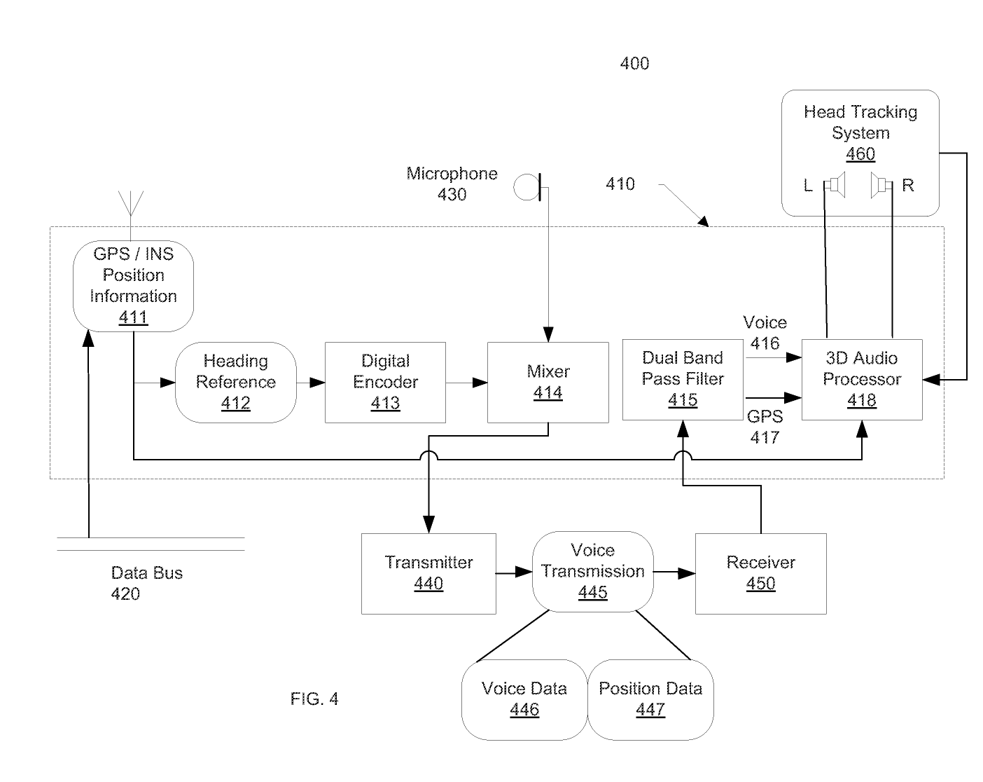

FIG. 4 is a bock diagram of another exemplary 3-dimensional audio system 400. The 3-dimensional audio system 400 includes a processing unit 410, a data bus 420, a microphone 430, a transmitter 440, a receiver 450, and a head tracking system 460. The processing unit 410 includes a digital encoder 413, a mixer 414, a dual band pass filter 415, and a 3D audio processor 418. The data bus 420 and/or an antenna provide GPS and/or internal navigation system (INS) position information (411) and heading reference (412) to the digital encoder 413 and the 3D audio processor 418. The digital encoder 413 encodes the position information (411) and/or the heading reference (412) into position data and sends the position data to the mixer 414. The mixer 414 receives voice data from the microphone 430 and mixes the voice data and the position data (also referred to as location data) to form a voice transmission 445. The mixer 414 sends the voice transmission 445 to the transmitter 440. The transmitter 440 transmits the voice transmission 445 to an appropriate receiver (e.g., receiver associated with the recipient of the voice transmission, all receivers within radio transmission distance, etc.). The mixing of the voice data 446 and the position data 447 into a combined voice transmission 445 advantageously enables the technology to quickly and efficiently determine a relative location of the receiver from the transmitter for the audio projection.

FIG. 4 illustrates the transmitter 440 transmitting the voice transmission 445 (position data 447 and voice data 446) to the receiver 450 in the same 3-dimensional audio system 400 for illustrative purposes only. The receiver 450 receives the voice transmission 445 from a transmitter. The receiver 450 sends the voice transmission 445 to the dual band pass filter 415. The dual band pass filter 415 filters the voice data 416 from the location data 417 (in this example, GPS) and sends the voice data 416 and the location data 417 to the 3D audio processor 418. The 3D audio processor 418 projects the voice data 416 in a 3D space via a plurality of speakers based on the position information (411) and the location data 417.

In some examples, the head tracking system 460 sends head position data to the 3D audio processor 418. The 3D audio processor 418 projects the voice data 416 in a 3D space via a plurality of speakers based on the position information (411), the location data 417, and the head position data, thereby keeping the audio in a fixed space when the user moves his/her head. In some examples, the receiver utilizes a digital compass to keep the audio in a fixed space when the user moves his/her head utilizing a fixed-point calculation relative to the digital compass rather than the user's head position.

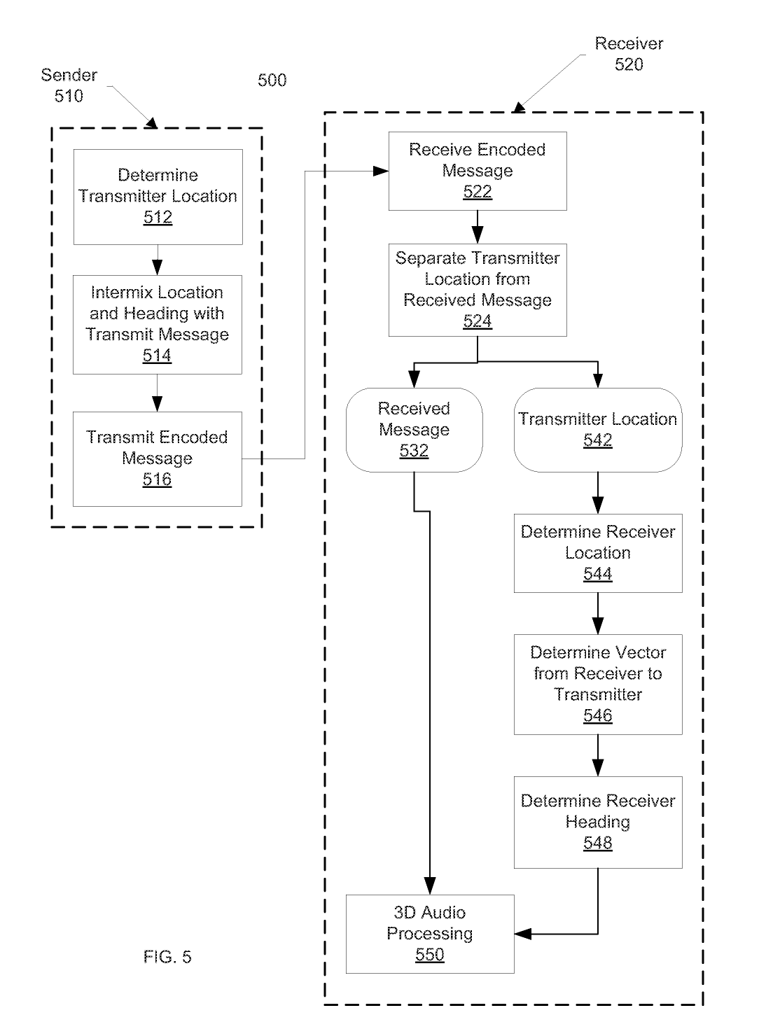

FIG. 5 is a flowchart 500 of an exemplary 3-dimensional audio projection method utilizing, for example, the environment 100 of FIG. 1. The processing of the flowchart 500 is divided between sender 510 and receiver 520 processing. In the sender 510 processing, the 3-dimensional audio system A 120a determines (512) location data for the transmitter (e.g., from GPS, from INS, etc.). The 3-dimensional audio system A 120a intermixes (514) the location data and a message for transmission (e.g., audio message, a video message, etc.) to form an encoded message (also referred to as a voice transmission). The 3-dimensional audio system A 120a transmits (516) the encoded message to the 3-dimensional audio system B 120b (the receiver in this example).

In the receiver 520 processing, the 3-dimensional audio system B 120b receives (522) the encoded message. The 3-dimensional audio system B 120b separates (524) the transmitter location data (542) and the received message (532). The 3-dimensional audio system B 120b determines (544) the receiver's location. The 3-dimensional audio system B 120b determines (546) a vector from the receiver to the transmitter based on the receiver's location and the transmitter location data (542). The 3-dimensional audio system B 120b determines (548) the receiver's heading. The 3-dimensional audio system B 120b processes (550) the received message (532), the vector, and the receiver's heading to project the audio from the received message (532) into a 3-dimensional space.

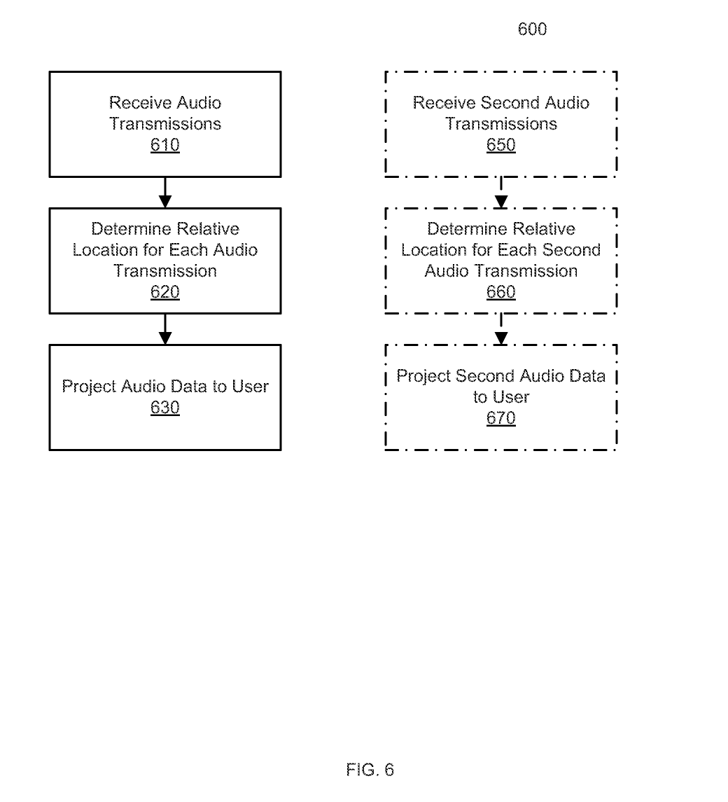

FIG. 6 is a flowchart 600 of another exemplary 3-dimensional audio projection method utilizing, for example, the environment 100 of FIG. 1. The airplane A 110a receives (610) a set of audio transmissions. Each of the audio transmissions in the set of audio transmissions includes audio data and location data. The airplane A 110a determines (620), for each of the audio transmissions in the set of audio transmissions, a relative location of the audio transmission based on a location of a receiver and the location data. The airplane A 110a projects (630), for each of the audio transmissions in the set of audio transmissions, the audio data to a user in a 3-dimensional format based on the relative location.

In some examples, the airplane B 110b receives (650) another set of audio transmissions. Each of the audio transmissions in the other set of audio transmissions includes audio data and location data. The airplane B 110b determines (660), for each of the audio transmissions in the other set of audio transmissions, a relative location of the audio transmission based on a location of a receiver and the location data. The airplane B 110b projects (670), for each of the audio transmissions in the other set of audio transmissions, the audio data to a user in a 3-dimensional format based on the relative location.

In other examples, each of the audio transmissions in the set of audio transmissions and each of the audio transmissions in the other set of audio transmissions are received on a same communication channel (e.g., channel 9, single satellite transmission channel, etc.). In some examples, each of the audio transmissions in the set of audio transmissions are received at a first time, each of the audio transmissions in the other set of audio transmissions are received at a second time, and the first time and the second time are different (e.g., 4:03.22 and 4:04.22, 5:02.22 and 5:02.23, etc.). In some examples, the relative location for each of the audio transmissions in the set of audio transmissions comprises a vector between the receiver and a transmitter location.

In other examples, the technology utilizes digital transmissions over an opto-electrical medium (e.g., fiber optics, coaxial cable, ethernet cable, etc.) for the transmission of the voice stream. In some examples, the 3D audio projection is based on the fixed (i.e., non-moving) locations of the transmitter and receiver.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by special purpose logic circuitry and/or an apparatus can be implemented on special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from, and/or can transfer data to one or more mass storage devices for storing data (e.g., magnetic, magneto-optical disks, optical disks, etc.).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A 3-dimensional audio system, the system comprising:
a communication module configured to receive a plurality of audio transmissions, each of the plurality of audio transmissions comprises audio data and location data and the location data being associated with a transmitter location;
an audio location module configured to determine, for each of the plurality of audio transmissions, a relative location of the audio transmission based on a location of the system and the location data; and
an audio projection module configured to 3-dimensionally project, for each of the plurality of audio transmissions, the audio data to a user based on the relative location of the audio transmission.

2. The system of claim 1, wherein each of the plurality of audio transmissions are received on a same communication channel.

3. The system of claim 1, wherein the plurality of audio transmissions comprises two or more audio transmissions transmitted from a transmitter at different locations and at different times.

4. The system of claim 1, wherein the plurality of audio transmissions comprises two or more audio transmissions transmitted at a same time from different users in a vehicle.

5. The system of claim 1, further comprising:
a user orientation module configured to determine an user orientation with respect to the location of the system; and
wherein the audio projection module further configured to 3-dimensionally project, for each of the plurality of audio transmissions, the audio data to a user based on the relative location of the audio transmission and the user orientation.

6. The system of claim 1, further comprising a location determination module configured to determine the location of the system.

7. The system of claim 1, further comprising an audio separation module configured to separate the audio data and the location data from the each of the plurality of audio transmissions.

8. A method for 3-dimensional audio projection, the method comprising:
receiving a first set of audio transmissions, each of the audio transmissions in the first set of audio transmissions comprises audio data and location data;
determining, for each of the audio transmissions in the first set of audio transmissions, a relative location of the audio transmission based on a location of a receiver and the location data; and
projecting, for each of the audio transmissions in the first set of audio transmissions, the audio data to a user in a 3-dimensional format based on the relative location of the audio transmission.

9. The method of claim 8, further comprising:
receiving a second set of audio transmissions, each of the audio transmissions in the second set of audio transmissions comprises second audio data and second location data;
determining, for each of the audio transmissions in the second set of audio transmissions, a second relative location of the audio transmission based on a location of the receiver and the second location data; and
projecting, for each of the audio transmissions in the second set of audio transmissions, the audio data to a user in a 3-dimensional format based on the second relative location of the audio transmission.

10. The method of claim 9, wherein each of the audio transmissions in the first set of audio transmissions and each of the audio transmissions in the second set of audio transmissions are received on a same communication channel.

11. The method of claim 9, wherein each of the audio transmissions in the first set of audio transmissions are received at a first time, each of the audio transmissions in the second set of audio transmissions are received at a second time, and the first time and the second time are different.

12. The method of claim 8, wherein the relative location of the audio transmission for each of the audio transmissions in the first set of audio transmissions comprises a vector between the receiver and a transmitter location.

13. A computer program product, tangibly embodied in an information carrier, the computer program product including instructions being operable to cause a data processing apparatus to:
receive a set of audio transmissions, each of the audio transmissions in the set of audio transmissions comprises audio data and location data and each of the audio transmissions in the set of audio transmissions being associated with a distinct transmitter location;
determine, for each of the audio transmissions in the set of audio transmissions, a relative location of the audio transmission based on a location of a receiver and the location data; and
project, for each of the audio transmissions in the set of audio transmissions, the audio data to a user in a 3-dimensional format based on the relative location of the audio transmission.
